(19) United States
(12) Patent Application Publication
(10) Pub. No.: US 2004/0176477 A1
(43) Pub. Date: Sep. 9, 2004

(54) Chitosan powder

(75) Inventors: Gordon Robert Davison, Berks (GB); Clyde Gibbons, Middlesex (GB); Andrew David Watson, Surrey (GB); Mark Brian Ripley, Middlesex (GB); Axel Konig, Brussels (BE); Tyler Ann Dieringer, Fairfield, OH (US); Michael Joseph Roddy, Cincinnati, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/780,782

(22) Filed: Feb. 18, 2004

Related U.S. Application Data
(60) Provisional application No. 60/452,604, filed on Mar. 6, 2003.

(51) Int. Cl. B01F 17/00

(52) U.S. Cl. 516/77

(57) ABSTRACT

Process for making micro-sized chitosan in powder form comprising spray drying an aqueous suspension of nano-sized chitosan. There is also provided micro-sized chitosan powder obtainable according to that process and uses thereof.

### TECHNICAL FIELD

The present invention relates to a process for making chitosan in powder form. This process provides chitosan powders presenting improved bioactivity, solubility and other properties over traditional chitosan. The invention also relates to chitosan in powder form and uses thereof.

### BACKGROUND OF THE INVENTION

Chitin is the main constituent in the shells of crustaceans and is the most abundant naturally occurring biopolymer other than cellulose. Chitosan is derived from chitin and can be formed by deacetylation of chitin. Chitosan is commercially available in a wide variety of molecular weights (e.g., 1-2,000,000 Da) and usually has a degree of deacetylation ranging between 50% and 100%. Chitosan is used for a wide variety of purposes including water purification, cosmetics additives, food and nutrition supplements and medical care.

The properties and applications of chitosan are strongly linked to its morphology, structure and size and these are directly related to the process used for obtaining chitosan. For reasons of clarity, the chitosan obtained as the initial product from chitin will be referred to herein as primary chitosan and the chitosan obtained from the subsequent treatment of this primary chitosan will be referred as modified chitosan.

Traditional primary or modified chitosan may have a limited solubility, limited developed internal surface, large particle size, low water retention value and limited purity and bio-availability. Traditional chitosan is usually semi-crystalline and only soluble in acidic medium, typically in a pH range from 1 to 5; this may impose formulation restrictions. Another drawback of traditional chitosan being that it does not present optimum biological activity, mainly due to its dense semi-crystalline nature in solid form. As a result, traditional chitosan has limited efficacy when used in solid or powder form. Sometimes, chitosan is produced as a low concentration, high viscosity paste and this imposes a further limitation on formulation flexibility.

In view of the above discussion, there is a need for an improved form of modified chitosan which is soluble over a wider range of pH, with improved purity and bioactivity and other properties and permitting greater formulation flexibility. There is also a need for an improved form of modified chitosan which is bioactive, delivering, for example, improved anti-microbial activity from both solid (powder) and liquid forms (solution/suspension).

### SUMMARY OF THE INVENTION

According to a first aspect of the invention, there is provided a process for making micro-sized chitosan powder having a degree of crystallinity below about 1% when fully hydrated and being soluble in deionised water across the entire pH range of from about 1 to about 6.0, preferably from about 1 to about 6.3. The process comprises spray drying an aqueous suspension of nano-sized chitosan. Preferably, the starting nano-sized chitosan is itself soluble across the entire pH range of from about 1 to about 6.0, more preferably from about 1 to about 6.3.

Applicant has discovered that many of the known drying processes seem to impact negatively on the properties of the dried material or else are not economically viable or easily scalable to industrial level. For example, solutions of nano-sized chitosan present excellent anti-microbial activity, however, some drying processes would render the chitosan significantly less active. Surprisingly, it has now been found that spray drying of chitosan in the form of a nano-sized suspension or solution leads to a micro-sized chitosan in dry form, which maintains the anti-microbial activity while having improved physical properties over the initial nano-sized chitosan. The resulting micro-sized chitosan powder is in the form of spray-dried powder or agglomerate presenting the advantages of having large particle size (micro-sized) and a high porosity (providing improved solubility and anti-microbial activity in the dried state). The powder (or agglomerate) of the invention is safe from the health and environmental point of view. It presents good flowability and is easy to handle and store (as oppose to nano-sized powders). Additionally, the powder of the invention does not have static electricity and associated handling issues associated with traditional powders. The micro-sized chitosan powder produced by the process of the invention has excellent anti-microbial properties when formulated both in powder and liquid forms.

Chitosan in dried form, especially in the micro-sized powder form provided by the process of the invention, overcomes a number of disadvantages associated with chitosan in the form of a solution or paste, including for example transportation and storage issues. Also chitosan powder has higher resistance to spoilage than chitosan in solution or paste. Additionally, the micro-sized chitosan powder not only increases formulation flexibility in fluid compositions but also permits the direct incorporation of chitosan in bioactive form in dry formulations, such as detergent compositions in the form of powders or other solid forms. The micro-sized chitosan is smoother and more pleasant to the touch than traditional chitosan powders.

By “micro-sized” chitosan is herein meant chitosan having a mean size (measured using a laser scattering particle size distribution analyser as explained herein below), based on a volume distribution, in the sub-millimeter range, specifically from about 0.001 mm to about 0.999 mm. Preferably the micro-sized chitosan powder has a mean particle size of from about 1 to about 500 μm, more preferably from about 1 to about 50 μm. By “nano-sized” chitosan is herein meant chitosan having a mean size, based on a volume distribution, in the sub-micron range, specifically form 0.001 μm to 0.999 μm. Preferably the nano-sized chitosan has a particle size of from about 100 to about 700 nm and more preferably from about 400 to about 600 nm.

In a preferred embodiment the micro-sized chitosan powder has a moisture content of less than about 20%, preferably less than about 15% and a concentration of impurities, such as inorganic salts of organic or inorganic acids or any other remaining additive from the chitosan making process, of less than about 20%, preferably less than about 15% and more preferably less than 12% by weight thereof. A low impurity concentration is usually desirable for physiological applications. The moisture content is calculated by the method described hereinbelow. Preferably the micro-sized chitosan powder has a specific density of from about 1100 to about 1600 Kg/m³, preferably from about 1200 to 1500 Kg/m³ as measured by gas displacement pycnometry using a Quantachrome Instrument Autosorb 1 apparatus.

The micro-sized chitosan powder has a narrow particle size distribution, preferably at least 80%, more preferably at least 90% of the particles as measured by the method described hereinbelow have a particle size of from about 1 to about 500 μm, preferably from about 1 to about 100 μm and even more preferably from about 1 to about 50 μm. In a preferred embodiment, at least 90% of the micro-sized chitosan has a particle size from about 1 to about 50 μm and a mean size of from about 5 to about 10 μm.

In a preferred embodiment the micro-sized chitosan powder has a porosity, as calculated by mercury porosimetry, of from about 0.45 cm³/g to about 0.8 cm³/g, preferably from about 0.5 cm³/g to about 0.7 cm³/g and wherein at least 80% by volume of the pores has a radius of from about 200 nm to about 5000 nm. As a consequence of this narrow pore size distribution the properties of the chitosan are considerably uniform throughout the material.

The properties of the micro-sized chitosan powder are strongly related to the starting nano-sized chitosan. In a preferred embodiment the nano-sized chitosan is made by a process involving the steps of forming an aqueous solution of primary chitosan by dissolving chitosan in an aqueous acidic solution followed by neutralizing said solution by means of a neutralizing agent. The neutralization is preferably carried out to the point at which the chitosan just precipitates to form a suspension and thereafter the suspension is homogenized by subjecting it to high shear. The precipitated chitosan is then preferably washed with de-ionized water to a conductivity below 1.6 milliSiemens/cm². The resulting chitosan aqueous suspension is substantially pure chitosan with a maximum impurity concentration, especially inorganic salts of organic acids, of less than 15%, preferably less than 12% and more preferably less than 5% by weight of chitosan.

In another preferred embodiment the nano-sized chitosan is obtained by wet milling primary or modified chitosan. The resulting nano-sized chitosan has a lower molecular weight, increased amorphous nature and increased solubility compared with the starting material. This leads to a superior anti-microbial activity. The anti-microbial activity of the chitosan can be evaluated by measuring the Minimum Inhibitory Concentration (MIC) value for a given microorganism (as described herein below). In a preferred embodiment the nano-sized chitosan obtained by the wet milling process has a Minimum Inhibitory Concentration for Malassezia furfur (related to dandruff) and for Staphylococcus epidermidis (related to fabric malodour) of less than about 100 ppm, preferably less than about 50 ppm and more preferably less than about 20 ppm.

The process of wet milling primary or modified chitosan can be used for size reduction and also for molecular weight reduction. Nano-sized chitosan having a molecular weight of form about 1,000 to about 150,000 Da, preferably from about 1,000 to about 7,000 Da can be obtained by means of wet milling. This process is particularly attractive for the reduction of the molecular weight of chitosan. The process is reproducible and economic, as compared to an enzymatic process, or other molecular weight reduction processes. Chitosan having a molecular weight of from about 1,000 to about 7,000 Da, namely chitosan oligomers, is widely used, for its solubility and anti-microbial properties.

According to another aspect of the invention, there is provided a process for making nano-sized chitosan by wet milling primary or modified micro-sized chitosan. The milling process preferably takes place in a stirred media mill comprising a screen provided with apertures and a grinding medium of uniform size. The process preferably comprises at least two size reduction steps wherein the mean size of the medium of the first step is at least three times the mean size of the medium of the second step and wherein preferably the size of the screen apertures in each step is smaller than the corresponding mean size of the medium and at least twice the mean size of the starting micro-sized chitosan. It has now been discovered that the requisite size of the screen apertures is a trade-off between the size of the grinding medium and the starting size of the micro-sized chitosan. If the screen apertures are too large the medium would not be retained in the mill, however if they are too small the screen is prone to blocking leading in turn to a large pressure build-up which can lock up the mill, requiring interruption of the milling operation in order to clean the equipment. The milling process can be modified by adding modifiers such as surfactants, emulsifiers, bulking agents, emulsion stabilizers, disintegrants, to the suspension to be milled. These modifiers may alter the properties of the resulting material or alternatively they may be ingredients which improve the performance of chitosan in a given formulation. For example, if the modifier agent is a disintegrant, the resulting material will comprise a disintegrant which can contribute to a faster delivery of active chitosan.

By “uniform size” grinding medium is herein meant that at least about 90%, and preferably all the individual particles of the grinding medium differ in size from the mean by less than 20%, preferably less than 10% and even more preferably by less than 5%. Without being bound by theory, it is believed that a uniform size grinding medium leads to milled particles having a narrow size distribution. The starting size of the grinding medium particles should be significantly larger than the initial particle size of the material to be milled. In a preferred embodiment the mean size of the grinding medium used at each step is at least about 5 times greater than the initial mean size of the chitosan to be milled in the corresponding step. The lower limit to which a particle can be reduced seems to be limited by the particle size of the grinding medium.

Where the size of the starting micro-sized chitosan is small enough, for example the mean volume particle size is less than 50 μm and less than 10% by volume of the particles have a particle size greater than 100 μm, nano-sized chitosan can be obtained by one step wet milling process.

Thus, according to another aspect of the invention there is provided a process for making nano-sized chitosan by wet milling micro-sized chitosan having a mean volume particle size of less than 50 μm and less than 10% of the particles, preferably less than 5% by volume having a particle size greater than 100 μm.

In a preferred embodiment the wet milled chitosan has a mean particle size of from about 200 to about 800 nm, preferably from about 300 to about 700 nm and more preferably from 400 to 600 nm.

Mean particle size as used herein referrers to the volume mean particle size. The chitosan mean particle size is measured with a Horiba LA-910 Laser Scattering Particle Size Distributor Analyser.

Nano-sized chitosan obtained by any suitable means such as for example the precipitation process described herein above, the wet milling process or from commercially available sources, is mixed with water to form an aqueous suspension comprising from about 1% to about 5%, preferably from about 2% to about 4% and more preferably about 3% by weight of chitosan. Said suspension is spray dried in for example a spray drying tower. In a preferred embodiment, the spray drying is performed co-currently at an air flowrate of from about 500 to about 1000 l/hr at an inlet air temperature of from about 100 to about 300° C. The dried powder obtained can be sterilised by any suitable method, including microwave, gamma irradiation, ultra violet, auto-clave or pasteurisation. In a preferred embodiment, the micro-sized chitosan powder is sterilised by means of gamma irradiation, this being a cost effective method which is simple to perform. The sterilised micro-sized chitosan presents prolonged storage stability and permits formulations in which sterility is critical, such as feminine protection or wound healing, without the use of preservatives. This chitosan can also be used for in vivo medical applications, such as temporary or permanent implants.

The micro-sized chitosan powder made according to the process of the invention has excellent anti-microbial activity, in dry and wet applications including formulations in emulsion form including oil-in-water emulsions and water-in-oil emulsions. In a preferred embodiment the micro-sized chitosan powder has a Minimum Inhibitory Concentration for Malassezia furfur and for Staphylococcus epidermidis of less than about 100 ppm, preferably less than 50 ppm and more preferably less than 20 ppm.

For optimum phase stability and anti-microbial activity, formulations in emulsion form are preferably prepared by a process comprising pre-forming the emulsion prior to addition of micro-sized chitosan powder. Thus, according to another aspect of the invention there is provided a method for making an emulsion comprising chitosan, said method comprising the steps of:

a) pre-forming an emulsion;

b) adding chitosan in the form of a powder or suspension; and preferably

c) adjusting the pH with a diluted acid solution to a pH of from about 1 to about 6.5 so as to solubilize the chitosan.

In a preferred embodiment the chitosan powder is in the form of micro-sized powder. Emulsions obtained according to this method present very high anti-microbial activity, having MIC values of less than about 100 ppm, preferably less than 80 ppm.

According to another aspect of the invention, there is provided the use of the chitosan powder for anti-microbial applications. Examples of fields where anti-microbial properties are desirable include hair care, skin care, personal cleansing, odour control, wound care, blood management, oral care, film formation, controlled release of hydrophobic or hydrophilic materials, hard surface, fabric treatment, plant care, seed, grain, fruit and food protection, water purification and drug delivery.

The micro-sized chitosan powder formulated into oral care products including dentifrices, mouth washes, gums and dental floss providing excellent anti-microbial properties including caries prevention and malodour reduction without staining the teeth enamel. The chitosan powder has a good residuality providing both rapid and long lasting anti-microbial benefits.

The micro-sized chitosan powder can also be formulated into products in single or dual liquid or gel form requiring a considerably smaller formulation volume than that provided by wet chitosan. Generally, when dried on a substrate following wet application the micro-sized chitosan powder of the invention delivers excellent sensorial properties as compared to wet nano-sized chitosan which has a high degree of stickiness. This makes the chitosan powder more desirable for applications involving direct or indirect contact with the skin. For example, chitosan powder used in fabric care compositions may improve the feeling of the fabrics. Additionally, the chitosan can provide malodour reduction. The chitosan powder can be activated by sweat providing a long lasting deodorant effect. Other benefits provided by micro-sized chitosan when formulated into fabric care compositions are softness, wrinkle reduction, colour care, dye-fixation and dye-transfer inhibition. The micro-sized chitosan powder can also be used for colour care in hair care as a dye fixative.

### DETAILED DESCRIPTION OF THE INVENTION

The present invention envisages a process for making micro-sized chitosan in powder form and chitosan powder obtained according to that process. The chitosan powder presents superior properties, leading to superior anti-microbial activity over other known forms of primary and modified chitosan. The invention also envisages uses of said chitosan.

Solubility Evaluation

The solubility of chitosan is evaluated by means of turbidity measurements. A 1% suspension of chitosan in distilled water is prepared. After 12 hours the pH of the suspension is measured at 21° C. under a continuous shear of 600 rpm. The pH of the suspension is modified by adding 40% lactic acid solution in a drop wise manner. Aliquots of this suspension are taken at approximately 0.1 pH unit interval. The aliquot is placed in a plastic cuvet and the absorvance at 600 nm is measured using a Spectrophotometer calibrated with completely dissolved chitosan (for example a solution of chitosan at pH 2). The chitosan is considered to be completely dissolved when the absorvance is equal to the reference, i.e. zero.

Particle Size Measurement

Particle size distribution is determined by means of static light-scattering via a Horiba LA-910 Laser Scattering Particle Size Distribution Analyzer. As a whole, the unit is calibrated against 90-, 1.0-, and 0.3-micron standards. An alignment procedure of the light source within the instrument is conducted prior to each set of measurements. Proper alignment is indicated by the presence of four sensors on the instrument. Chitosan particles are dispersed in 250-300 ml of water by mechanical and ultrasonic agitation. On a scale of 1 (slowest) to 6 (fastest), a setting of 4 is used for both the circulation and mechanical agitation of the dispersion. Because of the high tendency for the particles to agglomerate, the samples need to be sonicated for 3-4 minutes before and then during the 20-second analysis. The optimum percent transmittance for the LAMP light source is between 84-94%. The relative refractive index used for measuring the particle size of chitosan in water is 1.32-0.00. The particle size results are presented as a volume-based distribution on a LogX-LinearY axis.

Degree of Crystallinity

The degree of crystallinity of the fully hydrated chitosan is measured herein by X-ray diffraction. The chitosan powder can be fully hydrated by placing the powder in a ten times weight excess of deionised water for 24 hours. A Scintag X1 (MV28423, Serial #218-295, 0336) powder x-ray diffractometer is used. The generator is operated at 40 kV/45 mA, powering a normal focus copper x-ray tube. A solid-state detector is used. The x-ray beam is collimated using incident beam slits of 2 and 4 mm and diffracted beam slits of 0.5 and 0.2 mm. Data are collected using a step-scan mode from 2 to 60 θ at 2.5 seconds/step and a step size of 0.04. The degree of crystallinity is calculated as the ratio of the area of the crystalline peaks to the sum of the areas of the crystalline peaks and the amorphous region from 7 to 49 θ. Results reported are generally based on the average of two calculations for each analysis or sufficient to ensure reproducibility.

Moisture Content Determination

5 g of a chitosan sample is accurately weighed to a predried (105° C., 1 hour) evaporating dish. The sample is then dried in an oven at 105° C. for a minimum of 4 hours and then allowed to cool over silica gel in a dessicater. The sample is then reweighed. Analysis is performed in duplicate. The moisture content is expressed as follows:

$$MoistureContent = \frac{InitialSample ( Wt ( g ) - \\ DriedSampleWt ( g )}{InitialSampleWt ( g )} \times 100 \%$$

The porosity is determined by using a Quantachrome Autoscan 60 instrument. 0.5 g of a chitosan sample is placed in a penetrometer tube with a stem volume for the mercury intrusion of 2 cm³. The penetrometer is then filled with mercury using the Autoscan filling station, and then transferred to the high pressure unit of the instrument. The pressure is raised from 14.7 PSI to 55,000 PSI, and then lowered back to 14.7 PSI, giving a full mercury intrusion-extrusion curve.

MIC Test

This test is performed in order to evaluate the anti-microbial activity of the chitosan. A doubling dilution series of the chitosan is prepared and tested against the corresponding micro-organism. MIC is the lowest concentration showing no growth. The test is performed in the following manner:

1. Solutions of given concentrations of chitosan in sterile water buffered to pH 5.5 with lactic acid are prepared.

2. Aliquots (50 μl) of these sterile solutions are dispensed into individual well microtitre plates.

3. A suspension of the corresponding micro-organism (for example Malassezia furfur) in peptone is prepared from a 48 hours agar culture.

4. A 15 μl aliquot of the suspension of step 3 is added to each of the well microtitre plates containing the aliquot solutions of step 2 in order to give an initial inoculum of approximately 10⁶ cfu/ml.

5. Steps 1 to 4 are repeated in triplicate for reproducibility purposes.

6. Positive controls containing only lactate acidified water and inoculum (no active) are also prepared.

7. Negative controls containing active solutions only (no inoculum) are prepared to ensure sterility of the solutions.

8. The microtitre plates are incubated at 35° C.

9. Following required incubation time (24 hours) a 0.5 ml aliquot from each dilution is taken and plated onto Dixon Agar.

10. The plates are incubated at 35° C. for a minimum of 72 hours and then assessed for growth and the MIC is determined.

Precipitation Process for the Manufacture of Nano-Sized Chitosan

The starting chitosan material can be any commercially available chitosan. Suitable chitosan sources may be those derived from shellfish, insects or may be fungally derived. Preferred for use herein are chitosan materials having a molecular weight from about 10,000 to about 500,000 Da. Alternatively, the starting chitosan material can be obtained from high molecular weight chitosan by means of: i) acid catalysed hydrolysis, by leaving the high molecular chitosan in an acid solution for a length of time sufficient to reduce the molecular weight to the desired value; ii) enzymatic hydrolysis, preferably using chitosanase; and iii) dry milling.

The acid used to dissolve the chitosan is preferably selected from acetic, maleic, citric, lactic, salicylic, hydrochloric acid and mixtures thereof. Preferred for use herein are lactic, acetic and hydrochloric acid, especially the latter for obtaining chitosan compositions in which the chitosan has a high water retention value. The concentration of chitosan in the dilute acidic solution is preferably from about 0.1% to about 10%, more preferably from about 0.5% to about 2% by weight, these values being preferred from the process viewpoint, in order to provide a solution with the right consistency and with the required degree of constraint for producing the desired final chitosan suspension. The pH is preferably in the range from about 1 to about 5. Crystallization inhibitors, as for example diethylene triamine penta (methyl phosphonic) acid, can be added to the solution to avoid premature seed formation which can become crystal growth centres.

The resulting acidic chitosan solution can be optionally filtered to remove insoluble impurities. The neutralization step is carried out by means of a neutralizing agent. Preferred for use herein as neutralizing agent is an aqueous solution comprising from about 0.01% to about 4%, preferably from about 0.05% to about 3% by weight of metal hydroxide, ammonium hydroxide, organic bases such as monoethanolamine or triethanolamine or mixtures thereof. Sodium hydroxide and ammonium hydroxide are preferred for use herein from the cost viewpoint.

Preferably, the solution is partially neutralized up to the point in which the solution becomes a precipitate suspension, the pH preferably being in the range of from about 6.5 to about 7.5, more preferably from about 6.7 to about 7.1. At this point the solution appearance changes from clear to opaque and takes the form of a milky dispersion. Preferably, the partial neutralization is carried out in two sub-stages, wherein the first sub-stage involves neutralization with a relatively concentrated neutralizing agent up to a pH from about 4 to about 6.7, preferably from about 5.3 to about 5.8, the second sub-stage involves the use of a relatively dilute neutralizing agent, preferably the neutralizing agent being diluted by a factor of at least 5, preferably at least 9 as compared with the neutralization agent used in the first sub-stage.

Afterwards, the suspension is subject to intensive homogenisation, during which it is preferred that the system has a Reynolds number of from about 8,000 to about 20,000, preferably from about 12,000 to about 16,000.

Reynolds number is defined by the following equation:

$$Re = \frac{ρ {D}^{2} N}{μ}$$

wherein ρ (kg/m³) is the density of the suspension, D is the diameter of the impeller (m), N is the rotation speed of the impeller (s⁻¹) and μis the apparent viscosity of the suspension (N s/m²).

It is believed that the morphology of the nano-sized chitosan produced using this process is to a great extent determined by the mixing regimen and more specifically by the shear at which the solution is subjected after neutralization. It has been found that in order to obtain nano-sized chitosan with optimum morphology and performance characteristics the precipitate suspension formed should be homogenized by subjecting it to a high shear. By high shear is generally meant a shear sufficiently high to obtain nano-sized particles. This high shear can be achieved using any kind of high shear mixing operation for example by stirring using an impeller having a speed of rotation of at least about 500 rpm, preferably at least about 600 rpm. It is also preferred that the system has an average shear rate of at least about 80 s⁻¹, preferably at least about 100 s⁻¹. Average shear rate is given by the following equation:

Γₐᵥ=kN

wherein Γₐᵥ(s⁻¹) is the average angular shear rate for the mixing, k is a proportionality constant which is a function of the type of impeller and the vessel configuration and N (s⁻¹) is the speed of the agitator. It has been found that for the majority of practical systems k lies in the range form about 10 to about 13. The above equation for average shear rate is defined in “Agitation of Non-Newtonian fluids” Metzner and Otto, AIChE Journal, 1957, Vol 3, No. 1, pages 3-10.

It is also preferred that the impeller has a tip speed of at least about 4 m/s, as given by the following equation:

Tip speed=(πND)

wherein D is the diameter of the impeller in meters.

Preferably, the mixing is carried out mainly under laminar regime conditions and using an impeller such that the ratio of the diameter of the impeller to the diameter of the mixing vessel is at least about 0.4, preferably at least about 0.5 and especially about 0.55, this being preferred from the viewpoint of obtaining a homogeneous suspension.

Preferably, the suspension is homogenized at a speed of at least about 500 rpm for a period of at least about 10 s, preferably at least about 15 min.

After the suspension has been homogenized the process can be continued by further neutralising the homogenized suspension by means of an aqueous solution of a neutralizing agent comprising from about 0.01% to about 1%, preferably from about 0.05% to about 0.5% by weight of metal hydroxide, ammonium hydroxide or mixtures thereof; and thereafter further homogenizing the neutralized suspension under a second application of high shear, preferably using a stirring speed of at least about 500 rpm, more preferably at least about 600 rpm. This high shear can be achieved by similar means to those described hereinabove. Without being bound by theory, it is believed that in this part of the process not only the shear has a strong influence on the output of the process but also the concentration of the neutralizing agent.

Preferably, the solution is further neutralized up to the point in which the suspension reaches a pH of from about 7.0 to about 7.8, preferably from about 7.2 to about 7.6. Afterwards, the suspension is homogenized, during which it is preferred that the system has a Reynolds number of from about 18,000 to about 35,000, preferably from about 22,000 to about 26,000. This homogenisation is carried out at high shear preferably for a period of at least about 10 s and more preferably at least about 15 min. Finally, the suspension can be purified by washing with deionised water in for example a filter bed to remove water-soluble impurities.

Wet Milling Process for the Production of Nano-Sized Chitosan

The starting chitosan material can be any commercially available marine or fungally derived chitosan as the raw material used to produce nano-sized chitosan by chemical means as described hereinabove.

A dispersion of primary or modified chitosan is held in a mixing chamber. The concentration of the dispersion generally ranges from about 1% to about 5%. The 5% limit is imposed by viscosity. A 3% dispersion is preferred from the handling view point. The chitosan dispersion is introduced into a mill by means of a peristaltic pump. Inside the mill chamber, there is an agitation shaft that surrounds an internal screen (as described in U.S. Pat. No. 4,620,673). The agitation shaft imparts energy to the grinding medium which collides with the chitosan particles contributing to size reduction. The internal screen permits the material to be ground to pass through and exit the mill. The number of passes of the material to be ground is determined by the desired final particle size to be achieved. The grinding medium is larger that the filter gap, precluding the medium from leaving the mill. The medium is returned to the milling chamber.

During the wet milling process to reduce particle size of the dispersion, another physiochemical process takes place. The molecular weight of the chitosan is also reduced with the number of passes of the material and concomitantly the final particle size. Therefore the wet milling process can also be used for the purpose of reducing the molecular weight of chitosan regardless the starting molecular weight and source.

Any suitable grinding medium can be used herein. Preferred for use herein are ceramic media, including yttria stabilized zirconia oxide (YTZ) and Zirconox (crystalline zirconia stabilized with cerium oxide). YTZ offers high density, high wear resistance, high sphericity, reduced contamination and superior hardness. This medium is available in sizes from 25 mm to 0.2 mm. Zirconox medium is available from 3.3 mm to 0.4 mm. Any YTZ particles (less than 1% yttrium, less than 12% zirconium) in the final milled product can be removed by centrifugation (5500×g for 30 mins) after solubilizing the wet milled chitosan. The chitosan can then be regenerated by spray drying directly from solution or by base precipitation with dilute caustic solution.

Sterilisation by Gamma Radiation

The micro-sized powder can be sterilised by means of gamma irradiation. The dry powder is exposed to high-energy radiation, which is powerful enough to destroy microorganisms, but does not alter the structure of the chitosan polymer. The material is sealed in containers and exposed to a uniform dose of radiation (25-40 kGy) generated from the natural decay of Cobalt 60.

Sterilisation by Steam Sterilisation (Autoclaving)

The micro-sized powder can be sterilised in an autoclave, for example, in a steam autoclave at about 120° C., 1 bar pressure for about 30 minutes. Aqueous chitosan dispersions of up to 25% by weight solid contents can be treated using this method, but more preferably 0.1-4%.

Spray Drying

The micro-sized chitosan particles can be produced from nano-sized aqueous chitosan paste (including solutions and suspensions) by spray drying without browning or side reactions observed in other thermal drying processes. The heat and mass transfer during drying occurs in the air and vapour films surrounding the droplet. This protective envelope keeps the particle at the saturation temperature. Provided the particle does not completely dry out, by exposure to too high an inlet temperature, evaporation will still occur. The temperature of the chitosan solid will therefore be cooler than the dryer outlet temperature. The short residence time of from about 1 to about 50 seconds, preferably form about 3 to about 10 seconds, in the drier minimises crystallisation of the particles.

Examples of suitable conditions for spray drying a solution of nano-sized chitosan are shown in the following table (A).

| Spray drying Parameters | |
|---|---|
| Inlet air temperature (° C.) | 190-220 |
| Outlet air temperature (° C.) | 89-100 |
| Air Flow (m³/min) | 3-10 |
| Dispersion feed rate (g/min) | 20-500 |
| Atomisation pressure (Barg/Psig) | 5.0-6.0 |
| Atomisation air flow (m³/min) | 26 |
| Cyclone pressure (mBar) | 32-36 |

### EXAMPLES

### Example 1

### Micro-Sized Chitosan Powder Obtained from Chemically Produced Nano-Sized Chitosan

The nano-sized chitosan is made by a process comprising two-main steps:

a) Dissolution of Chitosan in an Acidic Solution:

1980 g of deionised water are weighed into 10 l stainless steel vessel of 22 cm diameter (T). Stirring is started using and overhead stirrer (Heidolph RZR 2041) with 4-pitched-blade impeller of 12 cm diameter (D) (D/T=0.55). Stirring is carried out at 200 rpm (1.3 m/s tip speed). 20 g of chitosan, sourced from Primex having a molecular weight of approximately 150 kDa and degree of acetylation of 15-20% are added slowly to the vessel, whilst stirring, avoiding contact with the vessel walls or the impeller shaft. Before proceeding to the next stage the mixture is stirred for 5 minutes to allow suspended chitosan to wet. Then, 333 g of an 18% by weight of a lactic acid aqueous solution are added to the vessel to solubilise the chitosan. The resulting mixture is stirred at 200 rpm and maintained for further 10 minutes to allow the chitosan to be fully solubilised in the acidic solution. The resulting solution is filtered through a single 60 cm×60 cm layer of mercerised cotton (pre-rinsed in deionised water) fitted in a 6 litres polypropylene Buchner funnel, and the filtrate is collected in a 5 litres clean Buchner flask. This stage removes any insoluble contaminants.

b) Neutralization of the Resulting Acidic Solution:

The filtered acidic chitosan solution is returned to the 10 l stainless steel vessel and stirred at 200 rpm. A 1.5% by weight sodium hydroxide aqueous solution is added to the acidic chitosan solution at a rate of 20 m/min via a peristaltic pump (Watson Marlow 205 U) from 2 kg reservoir of 1.5% by weight sodium hydroxide solution. Addition is carried out at 200 rpm until the mixture reaches a pH of 6.85 or 6.90. The vessel content is then mixed at high speed, 600 rpm, for 15 minutes. The stirring speed is reduced to 200 rpm-250 rpm and 1.5% by weight sodium hydroxide is added at a reduced rate of about 12 m/min until pH 7.45-7.50 reached. The vessel content is mixed at high speed, ˜600 rpm (3.8 m/s tip speed) for 15 minutes. Then the stirring speed is reduced to 200 rpm-250 rpm for 5 minutes to remove air generated in high speed mixing stage. The vessel content is filtered through a single 60 cm×60 cm layer of mercerised cotton (pre-rinsed in deionised water) fitted in a 6 litres polypropylene Buchner funnel to remove waste liquid. Nanochitosan is insoluble and collects on the cotton layer. Vacuum may be used to speed up removal of waste liquid. Nanochitosan is washed with 3×1000 ml aliquots of deionised water. Excess water is removed by vacuum filtration. The washed nanochitosan material is weighed into a tared 1000 ml container. Deionised water is added to obtain 1000 g total and produce 1 kg of a solution comprising 2% by weight of nano-sized chitosan.

The solution comprising 2% by weight of nano-sized particles is pumped into a co-current spray drier at the rate of 8.5 kg/hr. The inlet and outlet temperatures are 220° C. and 100° C., respectively. The pressure in the drier is set at 6 bar and the Atomise Nozzle set to 26 m³/min. The spray dryer outlet is connected to a cyclone whose pressure is set between 32 and 40 mbar. The spray-dried chitosan is collected from the cyclone and stored in a collection vessel. The spray-dried chitosan is in the form of spherical micro-sized particles with amorphous structure and presents good solubility in water in a pH range of from 1 td 6.3. The micro-sized chitosan powder has MIC for M. furfur of 10 ppm and a MIC for S. epidermidis of 20 ppm.

Examples of other conditions used for spray drying a solution of nanochitosan following the method described in Example 1 are given in Table A (Spray Drying Parameters).

### Example 2

### Micro-Sized Chitosan Powder Obtained from Chemically Produced Nano-Sized chitosan. Pilot Production Scale

The nano-sized chitosan is made by a process comprising of three main steps:

a) Dissolution of Chitosan in an Acidic Solution:

50.75 kg of deionised water is weighed into a 120 l stainless steel vacuum vessel of 68 cm diameter (T). The use of a vacuum mixer prevents aeration of the product during processing. Stirring is performed using an agitator (with side scrapers) set to 28 RPM, alternating agitation direction every 5 minutes. 1.5 kg of chitosan, sourced from Primex having a molecular weight of approximately 100-180 kDa and degree of acetylation of 15-20% are added slowly to the vessel under vacuum. Before proceeding to the next stage the mixture is stirred for 5 minutes to allow suspended chitosan to wet. The mixture is then recirculated through the vessel through a homogeniser running at 3300-3800 rpm at a rate such that the contents of the vessel are fully recirculated every 1-2 minutes (3500-5000 l/hour). Then, 2.0 kg of an 85% by weight of a lactic acid aqueous solution are added to the vessel to solubilise the chitosan. The resulting mixture is stirred by agitation at 28 rpm, while recirculating through the colloid mill at 1-2 vessel changes per minute at 3300-3800 RPM (5000 l/hour) for 10 minutes to allow the chitosan to be fully solubilised in the acidic solution. This stage removes any insoluble contaminants.

b) Neutralization of the Resulting Acidic Solution:

The filtered acidic chitosan solution is returned to the 120 l stainless steel vessel and stirred by agitation at 28 rpm, while recirculating through the colloid mill at 1-2 vessel changes per minute at 3300-3800 rpm (5000 l/hour). A 1.5% by weight sodium hydroxide aqueous solution is added to the acidic chitosan solution in vessel by vacuum at a rate of 500-650 g/minute from 50 kg reservoir of 1.5% by weight sodium hydroxide solution. Addition is carried out while stirring by agitation at 28 rpm and recirculating through the colloid mill at 1-2 vessel changes per minute at 3300-3800 rpm (5000 l/hour) until the mixture reaches a pH of 6.85 or 6.90. The colloid mill speed is increased to 4300 RPM for 15 minutes. The colloid mill is then decreased to 3500 rpm and 1.5% by weight sodium hydroxide is added at a reduced rate of about 200-400 g/min until pH 7.45-7.50 reached. The colloid mill speed is increased to 4300 RPM for 15 minutes. The mill speed is then reduced to 3300 rpm with agitation at 28 rpm.

c) Washing and Filtration Step

The vessel contents are recirculated through two 1 m Memtech ultrafiltration columns (each packed with 50 nm ceramic media with area 0.2 m²) arranged in parallel. Ultrafiltration is continued until the vessel contents have been reduced to a half to a third of the original volume. At this point deionised water is added using a peristaltic pump or under vacuum to the feed tank and is adjusted to maintain the same flow as the permeation rate. Ultrafilitration is stopped when the conductivity of the chitosan suspension is <2.0 mS, pH 6.9-7.1, solids content is 3.0-4.0% w/w.

Spray Drying

The solution comprising 3-4% by weight of nano-sized particles is pumped into a co-current (Pilot Plant Scale) spray drier at the rate of 8.5 kg/hr. The inlet and outlet temperatures are 220° C. and 100° C., respectively. The pressure in the drier is set at 6 bar and the Atomise Nozzle set to 26 m³/min. The spray dryer outlet is connected to a cyclone whose pressure is set between 32 and 40 mbar. The spray-dried chitosan is collected from the cyclone and stored in a collection vessel. The spray-dried chitosan is in the form of spherical micro-sized particles with amorphous structure and presents good solubility in water in a pH range of from 1 to 6.3. The micro-sized chitosan powder has MIC for M. furfur of 10 ppm and a MIC for S. epidermidis of 20 ppm.

### Example 3

### Micro-Sized Chitosan Powder Obtained from Wet Milled Nano-Sized Chitosan

a) First step:

A 3% by weight chitosan dispersion is made by adding ChitoClear chitosan powder (available from Primex, having a volume mean particle size of about 100 μm) to purified water in a mixing chamber. The dispersion is then introduced into a mill through Tygon (06429-size 24) tubing by a MasterFlex I/P Easy Load peristaltic pump. The mill is a 0.6 L horizontal LabStar stirred media mill (model LS-1, type 993.06, as described in U.S. Pat. No. 4,620,673) from Netzsch Incorporated in Exton, Pa. The mill is equipped with a silicon carbide mill chamber, agitator shaft and a filter, having a 0.6 mm gap screen, for the first step. The mill is filled at about 85% of the chamber volume, with YTZ (yttria stabilized tetragonal zirconia) medium having a mean diameter of 1.0 mm. The mill is operated at 2200 rpm. After 30 passes through the mill (approximately 60 minutes total milling time) the volume mean particle size is reduced to about 1 micron. The dispersion is collected.

b) Second Step:

The mill is reloaded with YTZ media having an a mean diameter of 0.3 mm and a 0.2 mm ceramic gap screen was inserted into the mill. The collected, milled dispersion is milled a second time. The mill is again operated at 2200 rpm. After 120 min of milling time (80 passes through the mill) the volume mean particle size is further reduced to about 400 nm.

Examples of other conditions used for wet milling a solution of chitosan following the method described in Example 3 are given in the following table:

| Process parameters | Step 1 | Step 2 |
|---|---|---|
| Medium | 1 mm YTZ | 0.3 mm YTZ |
| Mill speed (rpm) | 2200-2850 | 2200-2900 |
| Pump speed (rpm) | 180-315 | 200-350 |
| Temperature (° C.) | 24-30 | 30-38 |
| Power input (kW/hr) | 1.2-2.2 | 1.4-2.2 |
| Chamber pressure (bar) | 0.3-0.5 | 0.4-0.7 |
| Average flow rate (ml/min) | 500 | 450 |
| Milling passes | 10-14 | 40-42 |

A 3% milled chitosan dispersion produced according to this process is spray dried using a Brinkmann Buchi Mini-Spraydryer B-191 under the following conditions:

| Spray drying parameters | |
|---|---|
| Inlet air temperature (° C.) | 200 |
| Outlet air temperature (° C.) | 100 |
| Air flow (ft³/min) | 20 |
| Dispersion feed rate (ml/min) | 20-30 |
| Spray air rate (l/hr) | 800 |

The resulting micro-sized spray dried chitosan presents a MIC for M. furfur of about 85 ppm and a MIC for S. epidermidis of about 40 ppm.

### Example 4

### Wet Milling to Produce Nano-Sized Chitosan with Reduced Molecular Weight

Example 3 is repeated with the following variations:

ChitoClear chitosan powder having a volume mean particle size of about 100 μm. The first step involves 40 passes, the volume mean particle size is reduced to about 30 μm. The second step involves 40 passes also. The resulting volume mean particle size is approximately 400 nm and the molecular weight is about 7680 Da.

### Example 5

Preparation of Micro-Sized Spray Dried Chitosan Containing Emulsions

The following ingredients are formulated into an emulsion:

| Formula A | % w/w |
|---|---|
| DEIONISED WATER | 69.98 |
| GLYCERINE | 15.00 |
| OIL PHASE INGREDIENTS (Stearates) | 12.00 |
| EMULSIFYING MINERAL OILS | 1.00 |
| SODIUM HYDROXIDE - 40% solution | 0.02 |
| Micro Sized Chitosan | 2.00 |
| | 100.000 |

The oil phase ingredients were heated to 75° C. The aqueous phase (Glycerine, sodium hydroxide plus water) was heated to 75° C. also. The oil phase was then added to the water phase under high shear to obtain a pre-formed emulsion. The micro-sized chitosan was then added to the hot pre-formed emulsion (as a suspension) before adjusting the pH to 5.5 with mild acid solution. This emulsion is stable and does not phase separate upon cooling. The emulsion presents a MIC value of 78 ppm against Staphylococcus epidermidis and Corynebacterium xerosis. Similar results are obtained with an emulsion containing 0.2% by weight of micro-sized chitosan.

1. A process for making micro-sized chitosan powder having a degree of crystallinity below about 1% when fully hydrated and being soluble in water across a pH range of from about 1 to about 6.3, the process comprising spray drying an aqueous suspension of nano-sized chitosan.

2. A process according to claim 1 wherein the nano-sized chitosan is soluble across the pH range of from about 1 to about 6.3.

3. A process according to any preceding claim wherein the chitosan powder has a moisture content of less than about 20% and a concentration of impurities of less than about 12% by weight thereof.

4. A process according to any preceding claim wherein the chitosan powder has a volume mean particle size of from about 5 to about 50 μm.

5. A process according to any preceding claim wherein the chitosan powder has a porosity, as calculated by mercury porosimetry, of from about 0.45 cm³/g to about 0.8 cm³/g and wherein at least 80% by volume of the pores have a radius of from about 200 nm to about 5,000 nm.

6. A process according to any preceding claim wherein the nano-sized chitosan is obtained by:
a) forming an aqueous solution of chitosan by dissolving chitosan in aqueous acid; and
b) partially neutralizing the solution formed in step a) by means of a neutralizing agent;
wherein the neutralization is carried out to the point at which the chitosan is precipitated to form a suspension and thereafter the suspension is homogenized by subjecting it to high shear.

7. A process according to any of claims 1 to 5 wherein the nano-sized chitosan is obtained by a wet milling process.

8. A process for making nano-sized chitosan by wet milling micro-sized chitosan in a mill comprising an apertured screen and a grinding medium of uniform size and wherein the process comprises at least two size reduction steps wherein the mean size of the medium of the first step is at least three times the mean size of the medium of the second step and wherein preferably the size of the screen apertures in each step is smaller than the corresponding mean size of the medium and at least twice the mean starting size of the micro-sized material.

9. A process according to claim 8 wherein the mean size of the grinding medium used at each step is at least about 5 times greater than the initial mean size of the chitosan to be milled in the corresponding step.

10. A process for making nano-sized chitosan by wet milling micro-sized chitosan having a mean volume particle size of less than 50 μm and less than 5% of particles having a particle size greater than 100 μm.

11. A process according to any of claims 8 to 10 wherein the wet milled chitosan has a mean volume particle size of from about 200 to about 800 nm.

12. A process according to any of claims 8 to 11 wherein the wet milled chitosan has a molecular weight of form about 1,000 to about 7,000 Da.

13. A process according to claim 7 wherein the nano-sized chitosan is obtained according to the wet milling process of any of claims 9 to 12.

14. Micro-sized chitosan powder obtainable according to the process of any of claims 1 to 7 or 13.

15. Micro-sized chitosan powder wherein the Minimum Inhibitory Concentration for Malassezia furfur and for Staphylococcus epidermidis is less than about 100 ppm.

16. A process according to any of claims 1 to 7 or 13 further comprising the step of sterilising the micro-sized chitosan powder by means of gamma-irradiation or by heat sterilisation.

17. A method for making an emulsion comprising chitosan, said method comprising the steps of:
d) pre-forming an emulsion;
e) adding chitosan in the form of a powder or suspension; and preferably
f) adjusting the pH so as to solubilize the chitosan.

18. Use of the micro-sized chitosan powder according to claim 14 for anti-microbial applications.
